(19) United States
(12) Patent Application Publication
(10) Pub. No.: US 2015/0139183 A1
(43) Pub. Date: May 21, 2015

(54) Cell Reselection Trigger Report

(71) Applicant: TELEFONAKTIEBOLAGET L M ERICSSON (PUBL), Stockholm (SE)

(72) Inventors: Jose Luis Pradas, Stockholm (SE); Waikwok Kwong, Solna (SE); Nianshan Shi, Jarfalla (SE)

(21) Appl. No.: 14/118,785

(22) PCT Filed: Oct. 1, 2013
(86) PCT No.: PCT/SE2013/051133

§ 371 Date: Nov. 19, 2013

Related U.S. Application Data
(60) Provisional application No. 61/745,715, filed on Dec. 24, 2012.

(51) Int. Cl. H04W 36/14; H04W 74/08; H04L 1/18; H04W 36/00

(52) U.S. Cl. CPC H04W 36/14; H04W 36/0005; H04W 74/0833; H04L 1/1812
USPC 370/331

(57) ABSTRACT

Mechanisms are provided for several aspects of network communications relating to a UE reporting cell reselection. These include how the network configures or indicates to the UE that it should report cell reselection to the network; how the UE indicates a cell reselection to the network; and how the RNC indicates to the Node-B that the UE is in need of cell reselection. Implementation of these mechanisms avoids the problems of a UE reselecting a cell and leaving voluminous data at the source cell, which may become lost, and a UE having common E-DCH resources being unable to reselect another cell, even when it leaves a serving cell's operating area.

This application claims priority to U.S. Provisional Patent Application Ser. No. 61/745,715, titled Cell Reselection Trigger Report in CELL_FACH, filed 24 Dec. 2012, the disclosure of which is incorporated herein by reference in its entirety.

### TECHNICAL FIELD

The present invention relates generally to wireless communication networks, and in particular to mechanisms for reporting cell reselection.

### BACKGROUND

Modern wireless communication networks have experienced unprecedented growth, both in technological sophistication (and concomitant features and capabilities) and in terms of geographic deployment and number of subscribers. This growth is facilitated—and indeed is largely possible as a result of—the codification of key technical details of wireless communication network structure and operation in a series of industry-wide specifications. The Third Generation Partnership Project (3GPP) is a collaboration between groups of telecommunications associations, which propose, agree upon, and publish technical standards for third generation networks and beyond. The 3GPP publishes the standards governing the operation of the Universal Mobile Telecommunications System (UMTS), a successor to the Global System for Mobile Communications (GSM) and General Packet Radio Services (GPRS). The Radio Access Network (RAN) of UMTS is the UMTS Terrestrial Radio Access Network (UTRAN). The 3GPP has further evolved the UTRAN and GSM based radio access network technologies, specifying, e.g., High Speed Downlink/Uplink Packet Access (HSDPA/HSUPA), Multiple-Input Multiple-Output (MIMO) transmission schemes, and the like. For example an uplink transport channel improving capacity and data throughput is the Enhanced Dedicated Channel (E-DCH), comprising numerous physical layer channels.

The specifications governing operation of each of these technological advances are published as a major revision, or “release” of the 3GPP standard. Mobile terminals, more generally referred to as user equipment (UE), are designed in conformance with, and certified to be compatible with, a particular release of the 3GPP standard. For example, the first UMTS network is specified in Release 99 (released in 2000). HSDPA is specified in Release 5 (2002); HSUPA is specified in Release 6 (2004). Enhanced UTRA (E-UTRA, also known as Long Term Extension, or LTE) is specified in Release 7 (2007).

The Radio Resource Control (RRC) protocol for UMTS and Wideband CDMA (WCDMA) handles the control plane signaling between User Equipment (UEs, also known as mobile stations) and the UTRAN. RRC defines a plurality of states in which UEs reside. Each state has defined activity and associated power consumption. To conserve battery life, UEs transition to successively lower power-consuming states as inactivity timers trigger. In decreasing order of power consumption, the RRC Connected Mode states are CELL_DCH (Dedicated Channel), CELL_FACH (Forward Access Channel, approximately 50% the power consumption of CELL_DCH), CELL_PCH (Cell Paging Channel, approximately 2% of CELL_DCH power consumption), and URA_PCH (UTRAN Registration Area Paging Channel).

In Release 99, the Forward Access Channel (FACH) is used for downlink (DL) transmission for UEs in the CELL_FACH state. The Radio Network Controller (RNC) is responsible for the scheduling of the transmission. The Node-B (the UTRAN base station) simply transmits the data the RNC sends down for a Transmission Time Interval (TTI). In Release 7, the CELL_FACH state was enhanced to receive the High-Speed Downlink Shared Channel (HS-DSCH). The RNC may send available data for a UE to the Node-B all at once and delegate the scheduling task to the Node-B. However, the rules for the UE to maintain mobility using cell reselection did not change. If a UE determines that a cell reselection should be performed, it does so without informing the network ahead of time. The network is only aware of the change after having received a cell update transmitted by the UE in a new (target) cell. In the meantime, the original (source) Node-B may continue transmitting the data it has remaining in the buffer for that UE. This data will be lost since the UE is no longer monitoring that cell.

Enhanced Uplink in CELL_FACH state was introduced in Release 8. When a UE has a common E-DCH resource, the UE can perform measurements which may be later used to perform cell re-selection; however, the UE is not allowed to perform cell re-selection while the UE has a common E-DCH resource. Only when the UE has released the common E-DCH resource can the UE perform a cell re-selection. Thus, if the UE has a common E-DCH resource and moves from one cell to another, the UE cannot perform cell reselection to the new cell. Accordingly, the UE may lose coverage and the RRC connection.

Further Enhancements for CELL_FACH are being standardized in Release 11. Some of these enhancements may result in UEs remaining longer in CELL_FACH state and transmitting more data in this state than in prior 3GPP Releases.

The 3GPP Release 7 and 8 enhancements of the CELL_FACH state with HS-DSCH and E-DCH transmissions have thus created a problem when a UE needs to reselect another cell during data transmission. When receiving data on HS-DSCH, the UE may simply reselect another cell, leaving possibly large quantities of data at the prior cell, waiting to be transmitted. When transmitting data on a common E-DCH, the UE is required to perform measurements and cell ranking, but it is forbidden to perform cell reselection. If the cell ranking indicates that a cell reselection to another cell is warranted, the UE is likely to be introducing considerable interference to the other cell, and it may even be in danger of losing coverage.

The Release 11 improvements do not address these problems. In Release 11, UEs may remain in CELL_FACH state longer, and may transmit more data. This implies that UEs located in the cell edge may have a greater effect on other surrounding cells by means of interference while the UE has a common E-DCH resource. Additionally, if the transmission is to persist longer, the probability of UEs moving from one cell to another is higher. Hence, the drop call probability is also increased.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, mechanisms are provided for several aspects of network communications relating to a UE reporting cell reselection. These include how the network configures or indicates to the UE that it should report cell reselection to the network; how the UE indicates a cell reselection to the network; and how the RNC indicates to the Node-B that the UE is in need of cell reselection.

One embodiment relates to a method, performed by a UE operative in a wireless communication network. Cell reselection criteria are received in a System Information Broadcast (SIB) from the network. The SIB includes information instructing the UE to report to the network whenever cell reselection criteria are satisfied. Neighboring cells are monitored for possible cell reselection. An indication that cell reselection criteria are satisfied is transmitted to the network, in response to the SIB instruction.

Another embodiment relates to a method, performed by a Radio Network Controller (RNC) operative in a wireless communication network. An indication, transmitted by a UE, that cell reselection criteria at the UE are satisfied, is received. In response to the indication that cell reselection criteria at the UE are satisfied, notice of the satisfaction of cell reselection criteria is sent to the current serving Node-B of the UE.

Yet another embodiment relates to User Equipment (UE) operative in a wireless communication network. The UE includes radio circuits including a transceiver operative to wirelessly communicate with one or more Node-Bs; memory operative to store software; and a processor operatively connected to the memory and transceiver. The processor is operative to receive cell reselection criteria in a System Information Broadcast (SIB) from the network, the SIB including information instructing the UE to report to the network whenever cell reselection criteria are satisfied; monitor neighboring cells for possible cell reselection; and transmit to the network an indication that cell reselection criteria are satisfied, in response to the SIB instruction.

Still another embodiment relates to a Radio Network Controller (RNC) operative in a wireless communication network. The RNC includes communication circuits operative to communicate with one or more network nodes; memory operative to store software; and a processor operatively connected to the memory and communication circuits. The processor is operative to receive an indication, transmitted by a User Equipment (UE), that cell reselection criteria at the UE are satisfied; and in response to the indication that cell reselection criteria at the UE are satisfied, send notice of the satisfaction of cell reselection criteria to the current serving Node-B of the UE.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a diagram of a UE in a first cell, moving toward a second cell.

FIG. 2 is a diagram of a UE moving into a second cell and triggering a cell reselection.

FIG. 3 is a diagram of a UE moving into a second cell, but remaining connected to a first cell.

FIG. 4 is a flow diagram of a UE triggering cell reselection and sending a report to the network.

FIG. 5 is a flow diagram of a UE triggering cell reselection and sending a report to the network only when it does not have a common E-DCH resource.

FIG. 6 is a functional block diagram of a RNC.

FIG. 7 is a functional block diagram of a UE.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

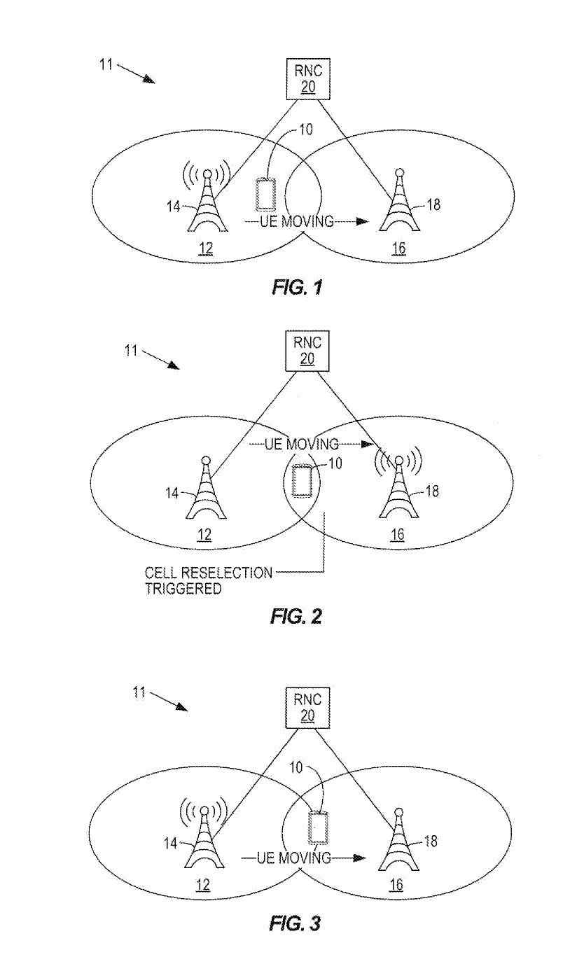

FIG. 1 depicts one problem with a UE in CELL_FACH state with HS-DSCH transmissions. A UE 10 in a wireless communication network 11 is connected to a first cell 12, established by a Node-B 14, as indicated by the RF emissions from the Node-B 14 tower. The UE 10 is moving toward a second cell 14, established by a Node-B 18. In this depiction, both Node-Bs 14, 18 are controlled by the same Radio Network Controller (RNC) 20, which may additionally control a plurality of other Node-Bs (not shown). Alternatively, the Node-B 18 may be controlled by a different RNC 20 than the Node-B 14.

The RNC 20 may download significant data to the first Node-B 14 in cell 12, for the Node-B 14 to schedule transmission to the UE 10. However, as depicted in FIG. 2, as the UE 10 moves into the region of the second cell 16, the UE 10 will perform a cell reselection to cell 16, as indicated by RF emissions from the Node-B 18 tower. The UE 10 then stops monitoring the first cell 12 and monitors only the second cell 16. This leaves the Node-B 14 at the first cell 12 with data to transmit to the UE 10, which data may be lost.

FIG. 3 illustrates a different problem. If the UE 10 had a common E-DCH resource in the first cell 12, it is not allowed to perform a cell reselection until the E-DCH resource is released. As the UE 10 moves toward and into a second cell 16, it must remain attached to the first cell 12, as indicated by RF emissions from the Node-B 14 tower. The UE 10 thus projects interference into cell 16, and may lose its connection to cell 12, causing loss of RRC and a dropped call. The Release 11 proposals that the UE 10 remain in CELL_FACH longer, and transmit more data, exacerbate both of these problems.

Cell reselection criteria for the CELL_FACH state is currently specified in the System Information Broadcast (SIB). According to embodiments of the present invention, additional information is included in the SIB to instruct the UE to inform the network 11 that the cell reselection criteria have been satisfied in the following cases:

(1) Any time cell reselection criteria is satisfied regardless of whether or not the UE has acquired a common E-DCH resource. In one embodiment, the reporting is limited to only when the UE has acquired a common E-DCH resource.

(2) The UE is allocated a common E-DCH. Additional information is included in the SIB that instructs the UE to periodically inform the network, after the first trigger, for as long as the cell reselection criterion remains satisfied. In one embodiment, in addition to the information for case (2), additional information may be included in the SIB to instruct the UE to suspend uplink transmission (except for HARQ retransmissions) until the completion of the cell reselection procedure.

(3) The UE has recently been receiving data on the HS-DSCH and the time elapsed since the last data reception is less than the value of a broadcast inactivity timer. Another broadcast parameter may be used to instruct the UE to wait for a certain amount of time before performing the cell reselection. The cell reselection indication may be sent on RACH or on a common E-DCH, depending on the capability of the UE and what has been configured in the network.

Alternatively, different cell reselection criteria may be specified in the SIB specifically for case (2) and for case (3).

The UE may convey a cell reselection to the network in several ways. The following embodiments depict independent and mutually exclusive methods, unless otherwise clearly indicated.

In one embodiment, the UE reports, in an RRC message, the event triggered “cell re-selection.” This event can be sent, for example, in a Measurement Report message. In the measurement report message, the UE will use the measurement identity indicated in the configuration given to the UE, or a default measurement identity may be used. The default measurement identity may be within the range from 1 to 16. In addition, the following information elements may be reported independently of each other:

In one embodiment, the UE reports an indication of whether cell reselection is triggered for an UTRA cell, GSM cell, or E-UTRA cell. In another embodiment, the UE also indicates a set of cells: for example, one or more UTRA cells, one or more GSM cells, and/or one or more E-UTRA cells. Combinations of RANs may be reported as well. For example, the UE could report cell reselection for one or more UTRA cells and also one or more E-UTRA cells. If a UTRA cell is reported, the UARFCN is included. If a GSM cell is reported, the ARFCN and Band Indicator are included. If a E-UTRA cell is reported, the EARFCN is included.

In another embodiment the Traffic Volume Measurement is reported if the network broadcasted the IE “Traffic volume measurement system information” in System Information Block Type 11.

In another embodiment, the UE sends a MAC-i PDU which includes the Scheduling Information. The scheduling information contains the following fields: UE Power Headroom (UPH), Total E-DCH Buffer Status (TEBS), Highest priority Logical channel Buffer Status (HLBS), and Highest priority Logical channel ID (HLID). Since the Node-B does not necessarily have knowledge of the reasons why a UE sends the Scheduling Information; it is required that a value in at least one of the fields in the Scheduling Information is reserved. This value, or values in different fields, will indicate that a UE is sending the Scheduling Information because a cell-reselection is triggered in the UE. TEBS information may be needed to assist the Node-B to evaluate the next actions. Hence, in one embodiment the UE reports the TEBS as in the prior art. UPH is also a necessary parameter. Hence, the two candidate fields to be used to indicate cell re-selection are the HLBS and/or HLID.

Another embodiment comprises the first embodiment described above, and in addition, the UE behavior with respect to the MAC-i/is entity. When a measurement report is triggered to indicate cell re-selection as described for the first embodiment 1, the Scheduling Information is also triggered.

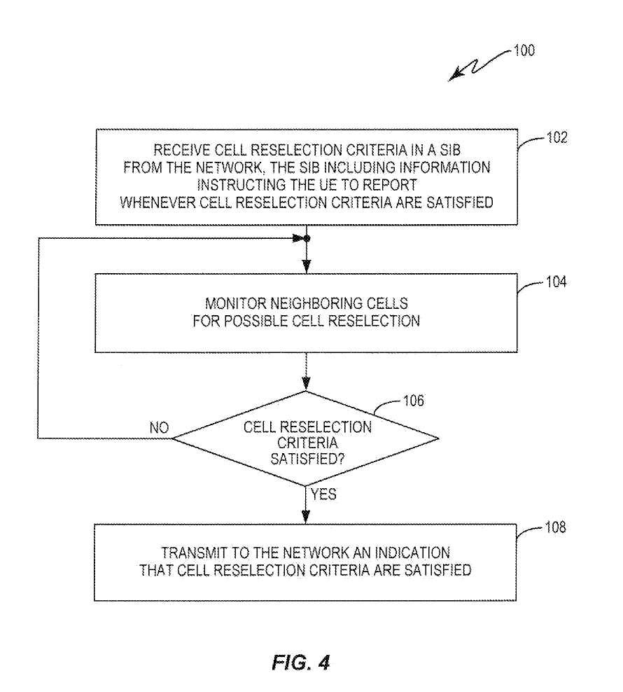

FIG. 4 depicts a method 100 performed by a UE 10 operative in a wireless communication network 11, according to embodiments described above. Initially, the UE 10 receives cell reselection criteria in a System Information Broadcast (SIB) from the network 11 (block 102). The SIB includes information instructing the UE 10 to report to the network 11 whenever cell reselection criteria are satisfied. The UE 10 periodically or continuously monitors neighboring cells 16 for possible cell reselection (block 104), comparing measurements against the cell reselection criteria received in the SIB. If the cell reselection criteria are satisfied (block 106), the UE 10 transmits to the network 11 an indication that cell reselection criteria are satisfied (block 108). In this manner, the network 11 is alerted to a pending cell reselection event, and take appropriate action to avoid the loss of data stockpiled at the Node-B 14 of the cell 12 to which the UE 10 is currently connected (see FIGS. 1-2).

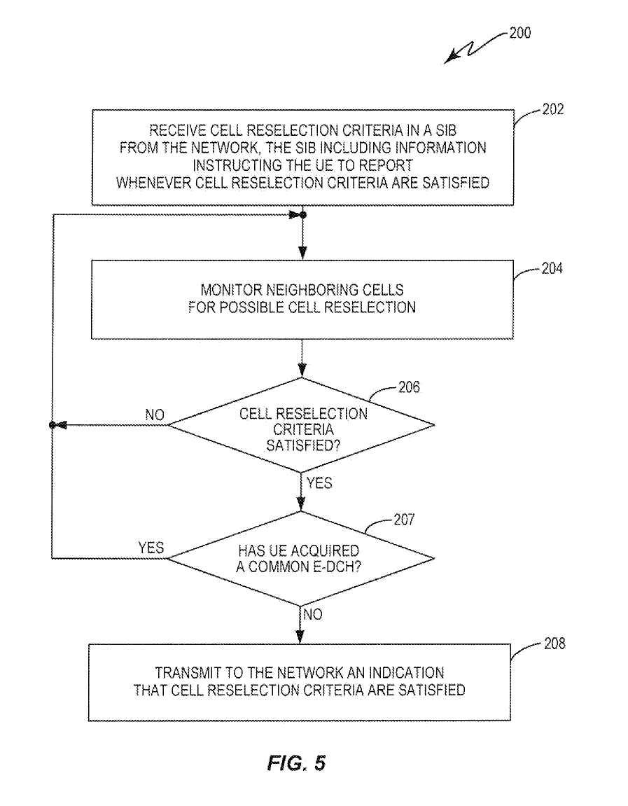

FIG. 5 depicts a method 200 performed by a UE 10 operative in a wireless communication network 11, according to other embodiments described above. In FIG. 5, blocks 202, 204, 206, and 208 correspond to blocks 102, 104, 106, and 108, respectively, of FIG. 4. In addition, FIG. 5 depicts the decision block 207, in which the UE 10 determines whether it has acquired a common E-DCH. In this method 200, only if cell reselection criteria are satisfied (block 206) and the UE 10 has a common E-DCH (block 207) does the UE 10 transmit to the network 11 an indication that cell reselection criteria are satisfied (block 108). In this manner, the network 11 may take appropriate action to prevent the UE 10 from causing excessive interference in a neighboring cell 16, when the UE 10 is prevented from actually performing an indicated cell reselection procedure due to the common E-DCH resource.

An RNC 20 may convey a cell reselection, reported by a UE 10 as described above, to a Node-B 14, 18 in several ways.

In one embodiment, when the RNC 20 receives a measurement report from a UE 10 indicating a cell reselection, as described above, the network 11 may decide to perform a reconfiguration. The RNC 20 performs admission control of the dedicated resources, and will setup a dedicated Radio Link at the target cell 18. According to one embodiment of the present invention, the RNC 20 will remove the common resources from the source cell 12. In this case, the network 11 will send a reconfiguration message to the UE 10. This reconfiguration message may, for instance, move the UE 10 to CELL_DCH state. In one embodiment, to maintain data flow to the UE 10 of data already delivered to the Node-B 12, the RNC 20 provides an activation time to the old resource to complete its data transfer. This is in addition to the known use of Connection Frame Number (CFN) used to indicate an activation time for the new resources.

In another embodiment, upon receiving the measurement report from a UE 10 indicating cell reselection, the RNC 20 may suspend downlink data transmission to the UE's current serving Node-B 12, and indicate to the Node-B 12 that the UE has indicated the need for cell re-selection. The RNC 20 may additionally indicate to the Node-B 12 the Traffic Volume Measurement reported by the UE, or other UE- or network-relevant information. The new indications can be added to a Node B Application Part (NBAP) or Radio Network Subsystem Application Part (RNSAP) control plane message. Alternatively, they can be added to the Iub/Iur user plane frame protocol.

In another embodiment, upon receiving the measurement report from a UE 10 indicating cell reselection, the RNC 20 does not suspend downlink data transmission to the UE's current serving Node-B 12, but does indicate to the Node-B 12 that it may release common E-DCH resources allocated to the UE 10. The RNC 20 may additionally indicate to the Node-B 12 the Traffic Volume Measurement reported by the UE, or other UE- or network-relevant information. The new indications can be added to a NBAP/RNSAP control plane message, or to the Iub/Iur user plane frame protocol.

The Node-B 12 may decide on further actions, such as releasing the common E-DCH resource by means of the Enhanced Absolute Grant Channel (E-AGCH). These actions may be based on the indication provided to the Node-B 12 as described in the embodiment above, on the amount of data the Node-B 12 has in its buffer for the UE 10, on the Traffic Volume Measurement (TVM) value provided by the RNC 20, and/or the Total E-DCH Buffer Status (TEBS) value indicated by the UE 10, or any relevant information provided by the UE 10, RNC 20, or information obtained or calculated by the Node-B 12.

If the Node-B 12 decides that the UE 10 may perform cell reselection, the Node-B 12 will explicitly release the common E-DCH resource. Following this, the UE 10 will perform a cell reselection before continuing to transmit data on the uplink.

In another embodiment, when the Node-B 12 receives the Scheduling Information (in the embodiment of UE 10 reporting cell reselection via a MAC-i PDU, as described above), the Node-B 12 sends the indication and TEBS value to the RNC 20. The RNC 20 may then perform the actions indicated in the various embodiments described above.

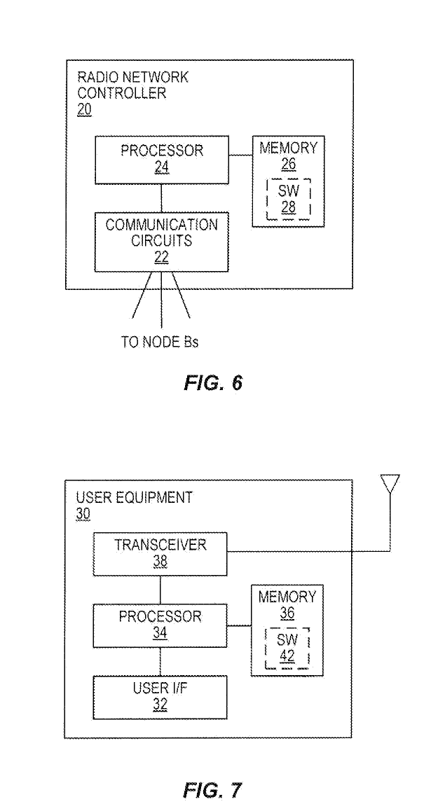

FIG. 6 depicts a RNC 20 operative in embodiments of the present invention. As those of skill in the art are aware, a RNC 20 is a network 11 node controlling one or more Node-Bs 14, 18. The RNC 20 includes communication circuitry 22 operative to exchange data with other network nodes; a processor 24; and memory 26. According to embodiments of the present invention, the memory 26 is operative to store, and the processor 24 operative to execute, software 28 which when executed is operative to cause the RNC 20 to perform methods and functions described herein.

FIG. 7 depicts a UE 30 operative in embodiments of the present invention. As those of skill in the art are aware, a UE 30 is a device, which may be battery-powered and hence mobile, operative within a wireless communication network. The UE 30 includes a user interface 32 (display, touchscreen, keyboard or keypad, microphone, speaker, and the like); a processor 34; memory 36; and a radio circuitry, such as one or more transceivers 38, antennas 40, and the like, to effect wireless communication across an air interface to one or more Node-Bs 14, 18. The UE 30 may additionally include features such as a camera, removable memory interface, short-range communication interface (Wi-Fi, Bluetooth, and the like), wired interface (USB), and the like (not shown in FIG. 7). According to embodiments of the present invention, the memory 36 is operative to store, and the processor 34 operative to execute, software 42 which when executed is operative to cause the UE 30 to perform methods and functions described herein.

In all embodiments, the processor 24, 34 may comprise any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

In all embodiments, the memory 26, 36 may comprise any non-transient machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

In all embodiments, the radio circuitry may comprise one or more transceivers 38 used to communicate with one or more other transceivers via a Radio Access Network according to one or more communication protocols known in the art or that may be developed, such as any of the 3GPP Releases described above. The transceiver 38 implements transmitter and receiver functionality appropriate to the Radio Access Network links (e.g., frequency allocations and the like). The transmitter and receiver functions may share circuit components and/or software, or alternatively may be implemented separately.

In all embodiments, the communication circuitry 22 may comprise a receiver and transmitter interface used to communicate with one or more other nodes over a communication network according to one or more communication protocols known in the art or that may be developed, such as Ethernet, TCP/IP, SONET, ATM, or the like. The communication circuitry 22 implements receiver and transmitter functionality appropriate to the communication network links (e.g., optical, electrical, and the like). The transmitter and receiver functions may share circuit components and/or software, or alternatively may be implemented separately.

Embodiments of the present invention provide numerous advantages over prior art implementations of the 3GPP specifications. In particular, they mitigate or prevent data loss when a UE performs a cell reselection while data remains buffered at the former Node-B. Additionally, embodiments described herein mitigate or eliminate interference, and possibly dropped calls, caused by a UE moving into a new cell but being unable to perform a cell reselection due to having been allocated common E-DCH resources.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-38. (canceled)

39. A method, by a UE operative in a wireless communication network, comprising:
receiving cell reselection criteria in a System Information Broadcast, SIB, from the network, the SIB including information instructing the UE to report to the network whenever cell reselection criteria are satisfied;
monitoring neighboring cells for possible cell reselection; and
transmitting to the network an indication that cell reselection criteria are satisfied, in response to the SIB instruction.

40. The method of claim 39 wherein transmitting to the network an indication that cell reselection criteria are satisfied in response to the SIB instruction comprises transmitting the indication only if the UE has acquired a common Enhanced Dedicated Channel, E-DCH, resource.

41. The method of claim 39 further comprising periodically transmitting to the network an indication that cell reselection criteria are satisfied, so long as the cell reselection criteria remain satisfied.

42. The method of claim 39 wherein transmitting to the network an indication that cell reselection criteria are satisfied comprises transmitting on the common E-DCH an indication that cell reselection criteria are satisfied.

43. The method of claim 39 wherein transmitting to the network an indication that cell reselection criteria are satisfied comprises transmitting on a Random Access Channel, RACH, an indication that cell reselection criteria are satisfied.

44. The method of claim 39, further comprising:
receiving uplink suspension information in the SIB instructing the UE to suspend all uplink transmission other than HARQ retransmissions until the completion of a cell reselection procedure;
monitoring neighboring cells for possible cell reselection;
performing a cell reselection procedure; and
during the cell reselection procedure, suspending all uplink transmission other than HARQ retransmissions.

45. The method of claim 39, further comprising:
receiving data on a High Speed Downlink Shared Channel (HS-DSCH);
receiving a cell reselection timer value in the SIB instructing the UE to wait a predetermined duration before performing cell reselection;
monitoring neighboring cells for possible cell reselection;
waiting the predetermined duration following cell reselection criteria being satisfied, in response to the time elapsed from the last data reception being less than a broadcast inactivity timer; and
after the predetermined duration, performing a cell reselection procedure.

46. The method of claim 39, further comprising:
performing a cell reselection procedure; and
transmitting to the network the event triggered “cell reselection” in a Radio Resource Control (RRC) message.

47. The method of claim 46 wherein the RRC message is a Measurement Report message.

48. The method of claim 47, further comprising:
receiving from the network a configuration including a measurement identity; and
wherein the Measurement Report message includes the configured measurement identity.

49. The method of claim 47 wherein the Measurement Report message includes a default measurement identity in the range from 1 to 16.

50. The method of claim 46 wherein the RRC message further includes an indication of whether cell reselection is triggered for one or more of a UTRA cell, GSM cell, or E-UTRA cell.

51. The method of claim 50 wherein the RRC message indicates cell reselection is triggered for at least one UTRA cell, and wherein the message further includes a UTRA Absolute Radio Frequency Channel Number, UARFCN.

52. The method of claim 50 wherein the RRC message indicates cell reselection is triggered for at least one GSM cell, and wherein the message further includes an Absolute Radio Frequency Channel Number, ARFCN, and a Band Indicator.

53. The method of claim 50 wherein the RRC message indicates cell reselection is triggered for at least one E-UTRA cell, and wherein the message further includes an EUTRA Absolute Radio Frequency Channel Number, EARFCN.

54. The method of claim 46 wherein the RRC message further includes a report of a Traffic Volume Measurement.

55. The method claim 54, further comprising:
receiving from the network the information element (IE) “Traffic volume measurement system information” in a System Information Block Type 11; and
wherein the RRC message only includes a report of a Traffic Volume Measurement in response to the IE.

56. The method of claim 39, further comprising:
performing a cell reselection procedure; and
transmitting to the network a MAC-i Protocol Data Unit (PDU) including Scheduling Information containing at least the following fields:
UE Power Headroom (UPH),
Total E-DCH Buffer Status (TEBS),
Highest priority Logical channel Buffer Status (HLBS), and
Highest priority Logical channel ID (HLID).

57. The method of claim 56 wherein one of the HLBS and HLID fields includes a cell reselection indicator.

58. User Equipment (UE) operative in a wireless communication network, comprising:
radio circuits including a transceiver operative to wirelessly communicate with one or more Node-Bs;
memory operative to store software; and
a processor operatively connected to the memory and transceiver and operative to
receive cell reselection criteria in a System Information Broadcast, SIB, from the network, the SIB including information instructing the UE to report to the network whenever cell reselection criteria are satisfied;
monitor neighboring cells for possible cell reselection; and
transmit to the network an indication that cell reselection criteria are satisfied, in response to the SIB instruction.

59. The UE of claim 58 wherein the processor is further operative to transmit to the network an indication that cell reselection criteria are satisfied in response to the SIB instruction by transmitting the indication only if the UE has acquired a common Enhanced Dedicated Channel (E-DCH) resource.

60. The UE of claim 58 wherein the processor is further operative to periodically transmit to the network an indication that cell reselection criteria are satisfied, so long as the cell reselection criteria remain satisfied.

61. The UE of claim 58 wherein the processor is further operative to transmit to the network an indication that cell reselection criteria are satisfied by transmitting on the common E-DCH an indication that cell reselection criteria are satisfied.

62. The UE of claim 58 wherein the processor is operative to transmit to the network an indication that cell reselection criteria are satisfied by transmitting on a Random Access Channel (RACH) an indication that cell reselection criteria are satisfied.

63. The UE of claim 58 wherein the processor is further operative to
receive uplink suspension information in the SIB instructing the UE to suspend all uplink transmission other than HARQ retransmissions until the completion of a cell reselection procedure;
monitor neighboring cells for possible cell reselection;
perform a cell reselection procedure; and
during the cell reselection procedure, suspend all uplink transmission other than HARQ retransmissions.

64. The UE of claim 58 wherein the processor is further operative to
receive data on a High Speed Downlink Shared Channel (HS-DSCH);
receive a cell reselection timer value in the SIB instructing the UE to wait a predetermined duration before performing cell reselection;
monitor neighboring cells for possible cell reselection;
wait the predetermined duration following cell reselection criteria being satisfied, in response to the time elapsed from the last data reception being less than a broadcast inactivity timer; and
after the predetermined duration, perform a cell reselection procedure.

65. The UE of claim 58 wherein the processor is further operative to
perform a cell reselection procedure; and
transmit to the network the event triggered “cell reselection” in a Radio Resource Control (RRC) message.

66. The UE of claim 65 wherein the RRC message is a Measurement Report message.

67. The UE of claim 66 wherein the processor is further operative to
receive from the network a configuration including a measurement identity; and
wherein the Measurement Report message includes the configured measurement identity.

68. The UE of claim 67 wherein the Measurement Report message includes a default measurement identity in the range from 1 to 16.

69. The UE of claim 65 wherein the RRC message further includes an indication of whether cell reselection is triggered for one or more of a UTRA cell, GSM cell, or E-UTRA cell.

70. The UE of claim 69 wherein the RRC message indicates cell reselection is triggered for at least one UTRA cell, and wherein the message further includes a UTRA Absolute Radio Frequency Channel Number (UARFCN).

71. The UE of claim 69 wherein the RRC message indicates cell reselection is triggered for at least one GSM cell, and wherein the message further includes an Absolute Radio Frequency Channel Number (ARFCN) and a Band Indicator.

72. The UE of claim 69 wherein the RRC message indicates cell reselection is triggered for at least one E-UTRA cell, and wherein the message further includes an EUTRA Absolute Radio Frequency Channel Number (EARFCN).

73. The UE of claim 65 wherein the RRC message further includes a report of a Traffic Volume Measurement.

74. The UE claim 65 wherein the processor is further operative to
receive from the network the information element (IE) “Traffic volume measurement system information” in a System Information Block Type 11; and
wherein the RRC message only includes a report of a Traffic Volume Measurement in response to the IE.

75. The UE of claim 58 wherein the processor is further operative to
perform a cell reselection procedure; and
transmit to the network a MAC-i Protocol Data Unit, PDU, including Scheduling Information containing at least the following fields:
UE Power Headroom (UPH),
Total E-DCH Buffer Status (TEBS),
Highest priority Logical channel Buffer Status (HLBS), and
Highest priority Logical channel ID (HLID).

76. The UE of claim 75 wherein one of the HLBS and HLID fields includes a cell reselection indicator.
